(19) United States
(12) Patent Application Publication
(10) Pub. No.: US 2012/0323798 A1
(43) Pub. Date: Dec. 20, 2012

(54) VALUATION OF PROPERTIES BORDERING SPECIFIED GEOGRAPHIC FEATURES

(75) Inventors: Nathan Pieter Den Herder, Falls Church, VA (US); Hamilton Fout, Rockville, MD (US); Steven L. Pierce, Annandale, VA (US); Eric Rosenblatt, Derwood, MD (US); John D. Treadwell, Washington, DC (US)

(73) Assignee: Fannie Mae, Washington, DC (US)

(21) Appl. No.: 13/162,819

(22) Filed: Jun. 17, 2011

(51) Int. Cl. G06Q 50/00; G06Q 30/00

(52) U.S. Cl. 705/306

(57) ABSTRACT

Modeling comparable properties and rendering map images with automatic valuation of properties bordering specified geographic features. A valuation model identifies and accounts for the proximity of properties to geographic features. For example, estimating property value includes accessing property data corresponding to a geographic area and performing a regression based upon the property data. The regression models the relationship between price and explanatory variables, with the explanatory variables including proximity to geographic features. Proximity may be a categorical variable wherein properties bordering the geographic feature are determined to possess the proximity characteristic. Alternative explanatory variables may incorporate different degrees of proximity.

### BACKGROUND OF THE INVENTION

1. Field of the Invention

This application relates generally to property valuation, more particularly to valuation of properties proximate to specified geographic features, and still more particularly to predicting values of properties that border specified geographic features using a geographic information system (GIS) and an automated valuation model (AVM).

2. Description of the Related Art

Geographic information systems (GIS) are tools that relate various kinds of data to geographic location data. They can be applied to any area where decisions will be made based on geographic distribution of data.

Automated valuation models (AVM) have seen increasing use in the real estate market since the 1990s when they first entered wide use by institutional investors in the market. They are used to reduce the time and money required to arrive at accurate prices for properties otherwise generated by individual human appraisers. The accuracy of the model is useful for those interested in prices of property, including realtors, private home owners, mortgage bankers, and secondary mortgage market participants. The impact of the market value of a home may differ depending on the interested party. For a homeowner it affects their equity position in the home, whereas the secondary mortgage market is concerned with the risk of default or prepayment which is heavily correlated with changes in the value of the real property backing the mortgage debt.

Regardless, accuracy is important to parties interested in property valuation. One area where accuracy can be affected involves proximity of the subject property to specific geographic features. Sometimes, the level of proximity to a feature (e.g., the ocean or another body of water) can have a very significant effect on valuation. However, accounting for proximity to many of these features appropriately would be difficult in the AVM environment, due to the high volume of property data and the irregularity of corresponding geographic features.

What is needed are improved modeling of comparable properties, and corresponding property valuation, including automated valuation modeling that predicts values of properties bordering specified geographic features.

### SUMMARY OF THE INVENTION

According to one aspect, the present invention models comparable properties and renders map images and associated information useful for analyzing comparable properties. Preferably, the valuation model identifies and accounts for the proximity of properties to geographic features. For example, the valuation model may automatically determine properties bordering a body of water and provide adjustments accordingly.

In one embodiment, estimating property value includes accessing property data corresponding to a geographic area and performing a regression based upon the property data. The regression models the relationship between price and explanatory variables, with the explanatory variables including proximity to geographic feature(s).

A subject property is identified, and a set of value adjustments is automatically determined based upon differences in the explanatory variables between the subject property and each of a plurality of comparable properties, with the set of value adjustments including a determination of the proximity to the geographic feature(s) for the subject property and the plurality of comparable properties. A value for the subject property is then estimated based upon the set of value adjustments.

In one example, only those properties bordering a geographic feature are considered to be sufficiently proximate to the geographic feature. There the explanatory variable may be a binary categorical variable. In other examples, different degrees of proximity may be implemented. In still other examples, distance may be used as a metric for determining sufficient proximity to the geographic feature, rather than direct bordering.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are block diagrams illustrating examples of systems in which a comparable property modeling and mapping application operates.

FIG. 2 is a flow diagram illustrating an example of a process for modeling comparable properties.

FIG. 3 is a flow diagram illustrating an example of modeling and mapping comparable properties.

FIG. 4 is a flow diagram illustrating a process for determining proximity to a geographic feature.

FIG. 5 is a flow diagram illustrating a process for determining proximate property parcels and further distinguishing bordering property parcels.

FIG. 6 is a block diagram illustrating an example of a comparable property modeling application with geographic feature proximity determination.

FIGS. 7A-D are display diagrams illustrating examples of map images and corresponding property grid data.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one aspect, the present invention models comparable properties and renders map images and associated information useful for analyzing comparable properties. Preferably, the valuation model identifies and accounts for the proximity of properties to geographic features. For example, the valuation model may automatically determine properties bordering a body of water and provide adjustments accordingly.

In one embodiment, estimating property value includes accessing property data corresponding to a geographic area and performing a regression based upon the property data. The regression models the relationship between price and explanatory variables, with the explanatory variables including proximity to geographic feature(s).

A subject property is identified, and a set of value adjustments is automatically determined based upon differences in the explanatory variables between the subject property and each of a plurality of comparable properties, with the set of value adjustments including a determination of the proximity to the geographic feature(s) for the subject property and the plurality of comparable properties. A value for the subject property is then estimated based upon the set of value adjustments.

In one example, only those properties bordering a geographic feature are considered to be sufficiently proximate to the geographic feature. In other examples, distance may be used as a metric for determining sufficient proximity to the geographic feature, potentially with further examination to identify bordering properties. Proximate properties may have an associated adjustment factor, and bordering properties another adjustment factor.

In one example, the determination of proximity entails accessing map data that provides a shape for the geographic feature, as well as for parcels corresponding to a subject property and comparable properties. The shape for the geographic feature is expanded, and then candidate parcels for proximity (e.g., bordering) are identified based upon whether the expanded shape overlaps the parcels corresponding to the properties.

Border logic may be applied to identify property parcels bordering the geographical feature. This, for example, may entail examining line(s) extending between location(s) designated for the geographic feature and location(s) designated for the parcels of candidate comparable properties. For example, bordering may be found where no intervening non-excluded parcel is present along the line between the geographic feature and the parcel for the candidate comparable property. In a more specific example, bordering may be found where no intervening non-excluded parcel is present along a line between a centroid of the parcel of the candidate comparable property and a midpoint of lines constituting the shape for the geographic feature. Still further, bordering proximity may be found where no intervening non-excluded parcel is present along lines between mid-points of the sides of the parcel of the candidate comparable property and a midpoint of lines constituting the shape for the geographic feature.

The regression modeling may vary, but in one example the property data is accessed and a regression models the relationship between price and explanatory variables (including at least one explanatory variable for geographic feature). For example, a hedonic regression is performed at a geographic level (e.g., county) sufficient to produce reliable results. A pool of comparables is identified, such as by initial exclusion rules based upon distance from and other factors in relation to a subject property. A set of adjustments for each comparable is determined using adjustment factors drawn from the regression analysis. The comparables may then be weighted and displayed.

Various types of explanatory variable scenarios for the geographic feature may also be implemented. In one example, the explanatory variable for proximity to the geographic feature is a categorical variable, with proximity determined only when the subject property borders the geographic feature. As another example, the explanatory variable for proximity to the geographic feature depends upon the physical distance between the subject property and the geographic feature.

A map image is displayed to illustrate the geographic distribution of the subject property and the comparable properties. An associated grid details information about the subject and comparable properties. The grid can be sorted according to a variety of property and other characteristics, and operates in conjunction with the map image to ease review of the comparables and corresponding criteria. The map image may be variously scaled and updates to show the subject property and corresponding comparables in the viewed range, and interacts with the grid (e.g. cursor overlay on comparable property in the map image allows highlighting of additional data in the grid).

(i) Hedonic Equation

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. The explanatory variables are:

(1) Four continuous property characteristics:

(a) log of gross living area (GLA),

(b) log of Lot Size,

(c) log of Age, and

(d) Number of Bathrooms; and

(2) five fixed effect variables:

(a) location fixed effect (e.g., by Census Block Group (CBG));

(b) Time fixed effect (e.g., measured by 3-month periods (quarters) counting back from the estimation date);

(c) Foreclosure status fixed effect, which captures the maintenance condition and possible REO discount;

(d) a “GIS” or Graphical Information Systems variable pertinent to proximity to particular geographical feature(s) of interest, such as roads, school districts, etc.;

(e) a “BF” or Border feature variable pertinent to bordering particular geographical feature(s) of interest, such as a lake or the ocean.

In one example, the BF feature may be a body of water, such the ocean, with oceanfront or other waterfront properties enjoying enhanced valuation. Any number “n” of such different BF features are determined and accommodated. Distance proximity to various other geographical features of interest are also provided according to the variable GIS. In this fashion, the BF variable may be used as a variable for border features, and the GIS variable may be used for distance proximity to various features.

With these explanatory variables, the example equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}} {FCL}_{k} + {\sum }_{m = 1}^{{N}_{GIS}} {GIS}_{m} + {\sum }_{n = \{ 0 , 1 \}} {BF}_{n} + ɛ \qquad ( Eq . 1 )$$

The above equation is offered as an example, and as noted, there may be departures. For example, although CBG is used as the location fixed effect, other examples may include Census Tract or other units of geographic area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

(ii) Exclusion Rules

Comparable selection rules are then used to narrow the pool of comps to exclude the properties which are determined to be insufficiently similar to the subject.

A comparable property should be located in a relative vicinity of the subject and should be sold relatively recently; it should also be of similar size and age and sit on a commensurate parcel of land. The “N” comparables that pass through the exclusion rules are used for further analysis and value prediction.

For example, the following rules may be used to exclude comparables pursuant to narrowing the pool:

(1) Neighborhood: comps must be located in the Census Tract of the subject and its immediate neighboring tracts;

(2) Time: comps must be sales within twelve months of the effective date of appraisal or sale;

(3) GLA must be within a defined range, for example:

$$\frac{2}{3} \leq \frac{{GLA}_{S}}{{GLA}_{C}} \leq \frac{3}{2}$$

(4) Age similarity may be determined according to the following Table 1:

TABLE 1

| | | | | | | | |
|---|---|---|---|---|---|---|---|
| Subject Age | 0-2 | 3-5 | 6-10 | 11-20 | 21-40 | 41-65 | 65+ |
| Acceptable Comp Age | 0-5 | 0-10 | 2-20 | 5-40 | 11-65 | 15-80 | 45+ |

(5) Lot size similarity may be determined according to the following Table 2:

TABLE 2

| Subject | <2000 | sqft | 2000-4000 | sqft | 4000 sqft-3 acres | >3 acres |
|---|---|---|---|---|---|---|
| Lot size | | | | | | |
| Acceptable Comp Lot | 1-4000 | sqft | 1-8000 | sqft | $\frac{2}{5} \leq \frac{{LOT}_{S}}{{LOT}_{C}} \leq \frac{5}{2}$ | >1 acre |

These exclusion rules are provided by way of example. There may be a set of exclusion rules that add variables, that omit one or more the described variables, or that use different thresholds or ranges.

(iii) Adjustment of Comps

Given the pool of comps selected by the model, the sale price of each comp may then be adjusted to reflect the difference between a given comp and the subject in each of the characteristics used in the hedonic price equation.

For example, individual adjustments are given by the following set of equations (2):

A_{gla}=exp└ ln(GLA_{S})−ln(GLA_{C}))·β_{gla}┘;

Aₗₒₜ=exp[ln(LOT_{S})−ln(LOT_{C}))·βₗₒₜ];

A_{age}=exp└ ln(AGE_{S})−ln(AGE_{C}))·β_{age}┘;

A_{bath}=exp└(BATH_{S}−BATH_{C})·β_{age}┘;

A_{loc}=exp[LOC_{S}−LOC_{C}];

Aₜᵢₘₑ=exp[TIME_{S}−TIME_{C}];

A_{fCl}=exp[FCL_{S}−FCL_{C}];

A_{gis}=exp[GIS_{S}−GIS_{C}]; and

A_{BF}=exp[BF_{S}−BF_{C}]. (Eq. 2)

where coefficients βgla, βlot, βage, βbath, LOC, TIME, FCL, GIS, BF are obtained from the hedonic price equation described above. Hence, the adjusted price of the comparable sales is summarized as:

$${p}_{C}^{adj} = {p}_{C} \cdot {{\prod {A}_{i}}_{i ∈ \{ gla , lot , age , bath , loc , time , fcl , gis , bf \}}}^{ } = {p}_{C} \cdot {A}_{TOTAL} \qquad ( Eq . 3 )$$

(iv) Weighting of Comps and Value Prediction

Because of unknown neighborhood boundaries and potentially missing data, the pool of comparables will likely include more than are necessary for the best value prediction in most markets. The adjustments described above can be quite large given the differences between the subject property and comparable properties. Accordingly, rank ordering and weighting are also useful for the purpose of value prediction.

The economic distance D_{eco} between the subject property and a given comp may be describe as a function of the differences between them as measured in dollar value for a variety of characteristics, according to the adjustment factors described above.

Specifically, the economic distance may be defined as a Euclidean norm of individual percent adjustments for all characteristics used in the hedonic equation:

$${D}_{SC}^{eco} = \sqrt{{\sum {( {A}_{i} - 1 )}^{2}}_{i ∈ \{ gla , lot , age , bath , loc , time , fcl , gis , bf \}}} \qquad ( Eq . 4 )$$

The comps are then weighted. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {D}_{SC}^{time}} \qquad ( Eq . 5 )$$

where D_{geo} is a measure of a geographic distance between the comp and the subject, defined as a piece-wise function:

$${D}_{SC}^{geo} = \{ \begin{matrix}0.1 & if {d}_{SC} < 0.1 mi \\ {d}_{SC} & if 0.1 mi \leq {d}_{SC} \leq 1.0 mi \\ 1.0 + \sqrt{{d}_{SC} - 1.0} & if {d}_{SC} > 1.0 mi ,\end{matrix} \qquad ( Eq . 6 )$$

and Dₜᵢₘₑ is a down-weighting age of comp sale factor

$${D}_{SC}^{time} = \{ \begin{matrix}1.00 & if ( 0 , 90 ] days \\ 1.25 & if ( 90 , 180 ] days \\ 2.00 & if ( 180 , 270 ] days \\ 2.50 & if ( 270 , 365 ] days\end{matrix} \qquad ( Eq . 7 )$$

Comps with higher weight receive higher rank and consequently contribute more value to the final prediction, since the predicted value of the subject property based on comparable sales model is given by the weighted average of the adjusted price of all comps:

$${\hat{p}}_{s} = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 8 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

According to another aspect, mapping and analytical tools that implement the comparable model are provided. Mapping features allow the subject property and comparable properties to be concurrently displayed. Additionally, a table or grid of data for the subject properties is concurrently displayable so that the list of comparables can be manipulated, with the indicators on the map image updating accordingly.

For example, mapping features include the capability to display the boundaries of census units, school attendance zones, neighborhoods, as well as statistical information such as median home values, average home age, etc. The mapping features also accommodate the illustration of geographical features of interest along comparable properties, offering visual depiction of properties that border the feature.

The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales.

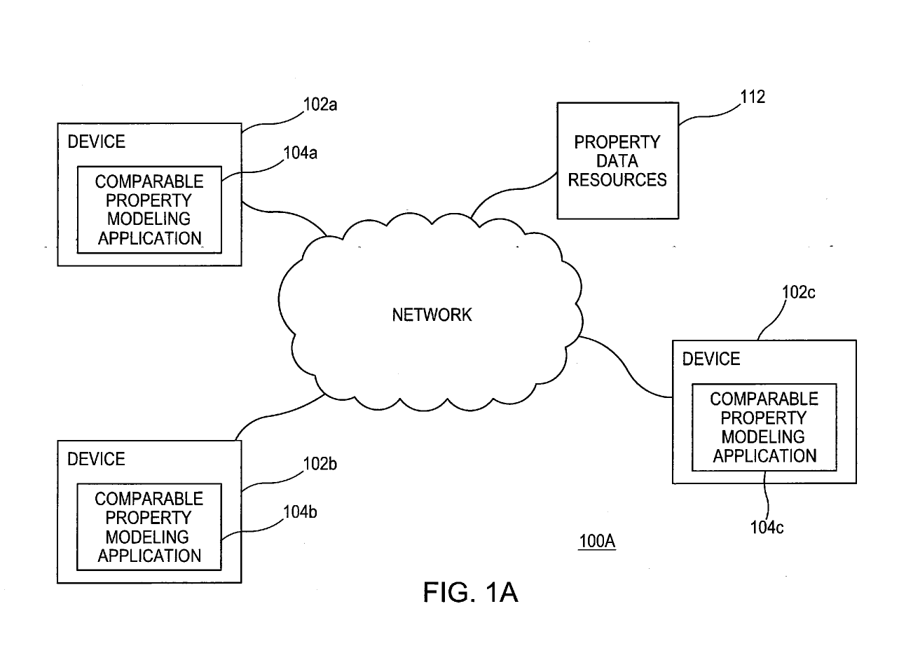

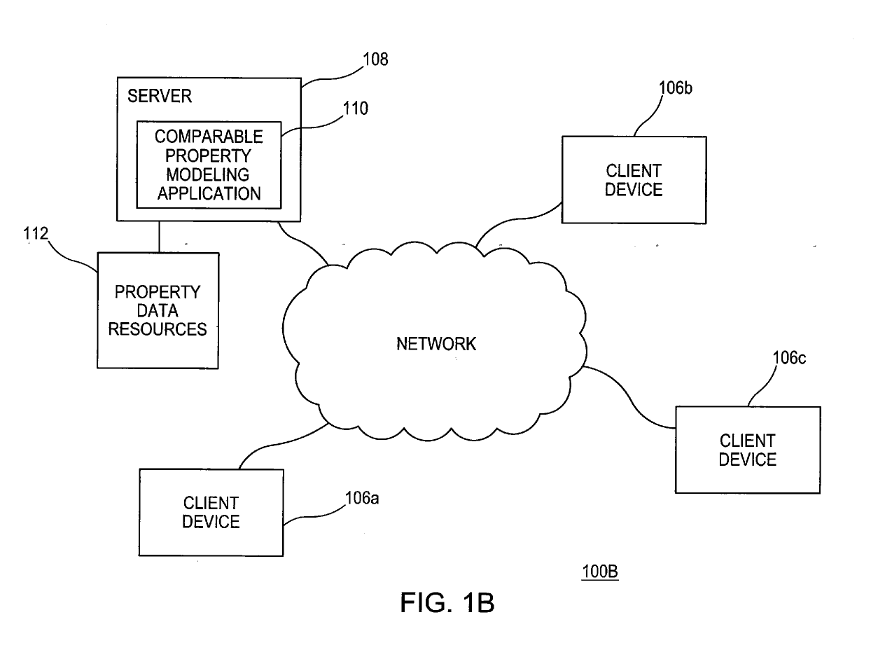

FIGS. 1A-B are block diagrams illustrating examples of systems 100A-B in which a comparable property modeling application operates.

FIG. 1A illustrates several user devices 102a-c each having a comparable property modeling application 104a-c.

The user devices 102a-d are preferably computer devices, which may be referred to as workstations, although they may be any conventional computing device. The network over which the devices 102a-d may communicate may also implement any conventional technology, including but not limited to cellular, WiFi, WLAN, LAN, or combinations thereof.

In one embodiment, the comparable property modeling application 104a-c is an application that is installed on the user device 102a-c. For example, the user device 102a-c may be configured with a web browser application, with the application configured to run in the context of the functionality of the browser application. This configuration may also implement a network architecture Wherein the comparable property modeling applications 104a-c provide, share and rely upon the comparable property modeling application 104a-c functionality.

As an alternative, as illustrated in FIG. 1B, the computing devices 106a-c may respectively access a server 108, such as through conventional web browsing, with the server 108 providing the comparable property modeling application 110 for access by the client computing devices 106a-c. As another alternative, the functionality may be divided between the computing devices and server. Finally, of course, a single computing device may be independent configured to include the comparable property modeling application.

As illustrated in FIGS. 1A-B, property data resources 110 are typically accessed externally for use by the comparable property modeling application, since the amount of property data is rather voluminous, and since the application is configured to allow access to any county or local area in a very large geographic area (e.g., for an entire country such as the United States). Additionally, the property data resources 110 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property modeling application accesses and retrieves the property data from these resources in support of the modeling of comparable properties as well as the rendering of map images of subject properties and corresponding comparable properties, and the display of supportive data (e.g., in grid form) in association with the map images.

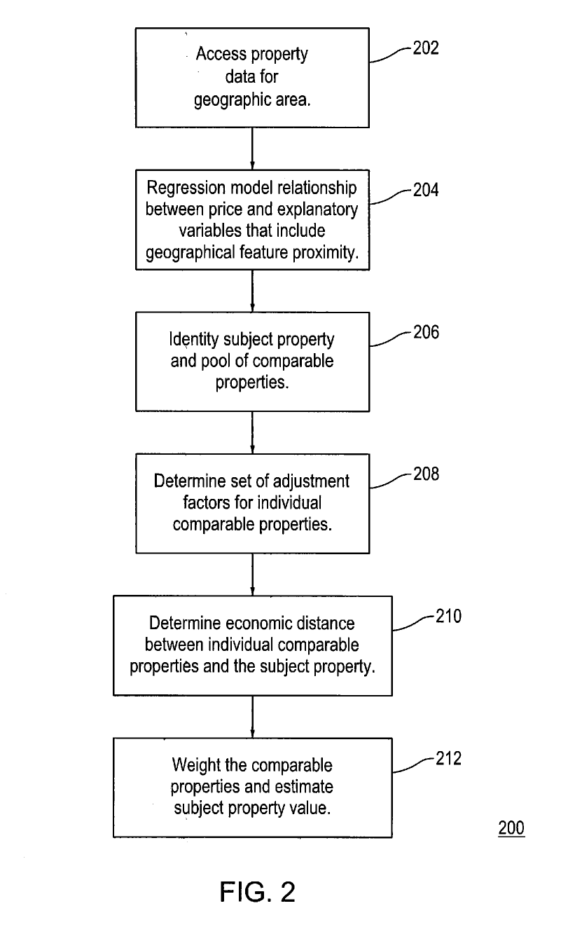

FIG. 2 is a flow diagram illustrating an example of a process 200 for modeling comparable properties, which may be performed by the comparable property modeling application.

As has been described, the application accesses 202 property data. This is preferably tailored at a geographic area of interest in which a subject property is located (e.g., county). A regression 204 modeling the relationship between price and explanatory variables is then performed on the accessed data. Although various alternatives may be applied, a preferred regression is that described above, wherein the explanatory variables are the four property characteristics (GLA, lot size, age, number of bathrooms) as well as the categorical fixed effects (border feature status, GIS feature proximity, location, time, foreclosure status).

A subject property within the county is identified 206 as is a pool of comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of comparable properties for each particular subject property.

The pool of comparable properties may be initially defined using exclusion rules. This limits the unwieldy number of comparables that would likely be present if the entire county level data were included in the modeling of the comparables.

Although a variety of exclusion rules can be used, in one example they may include one or more of the following: (1) limiting the comparable properties to those within the same census tract as the subject property (or, the same census tract and any adjacent tracts); (2) including only comparable properties where the transaction (e.g., sale) is within 12 months of the effective date of the appraisal or transaction (sale); (3) requiring GLA to be within a range including that of the subject property (e.g., +/−50% of the GLA of the subject property); (4) requiring the age of the comparable properties to be within an assigned range as determined by the age of the subject property (e.g., as described previously); and/or (5) requiring the lot size for the comparable properties to be within an assigned range as determined by the lot size of the subject property (e.g., as described previously).

Once the pool is so-limited, a set of adjustment factors is determined 208 for each remaining comparable property. The adjustment factors may be a numerical representation of the price contribution of each of the explanatory variables, as determined from the difference between the subject property and the comparable property for a given explanatory variable. An example of the equations for determining these individual adjustments has been provided above.

Once these adjustment factors have been determined 208, the “economic distance” between the subject property and respective individual comparable properties is determined 210. The economic distance may be constituted as a quantified value representative of the estimated price difference between the two properties as determined from the set of adjustment factors for each of the explanatory variables.

Following determining of the economic distance, the comparable properties may be weighted 212 in support of generating a ranking of the comparable properties according to the model. One example of a weighting entails a function inversely proportional to the economic distance, geographic distance and age of transaction (typically sale) of the comparable property from the subject property.

The weights may further be used to calculate an estimated price of the subject property comprising a weighted average of the adjusted price of all of the comparable properties.

Once the model has performed the regression, adjustments and weighting of comparables, the information is conveyed to the user in the form of grid and map image displays to allow convenient and comprehensive review and analysis of the set of comparables.

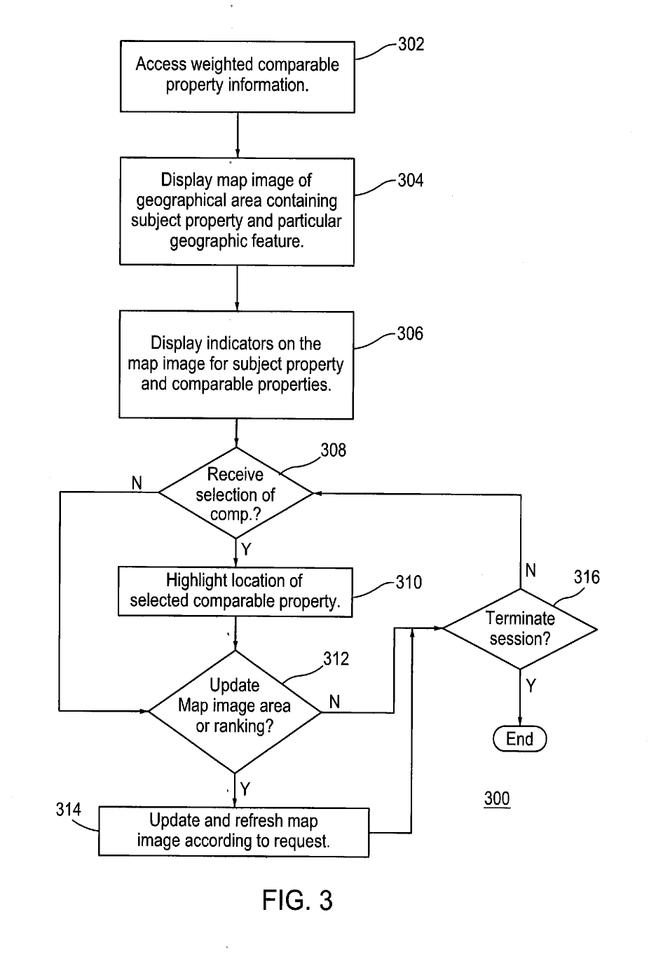

FIG. 3 is a flow diagram illustrating an example of a process 300 for modeling and mapping comparable properties with initial access 302 of the weighted comparable property information. This may be as described above, such as wherein the comparable properties are weighted according to the economic distance, geographic distance and age of transaction information.

The process also includes display 304 of a map image of a geographic area containing the subject property. The map image information may be acquired from conventional mapping resources, including but not limited to Google maps and the like. Additionally, conventional techniques may be used to depict subject and comparable properties on the map image, such as through determination of the coordinates from address information.

The map imagery may be various updated to provide user-desired views, including zooming in and out to provide more narrow or broad perspectives of the depictions of the comparable and subject properties. Additionally, the map imagery is updated to reflect the current display of various geographical features. In one example, a body of water may be depicted as a geographical feature in the map image, along with parcels corresponding to properties. Although one embodiment describes the determination of bordering status for a body of water, embodiments of the invention are not so-limited. For example, the model may implement determinations whether a property borders geographical features including highways or other major roads, parks, golf courses, mass transit, commercial properties/zones, cul-de-sacs, power plants, railroads, garbage dumps, etc.

The property data includes information as to the location of the properties, and either this native data may be used, or it may be supplemented, to acquire that exact location of the subject property and potential comparable properties on the map image. This allows the map image to be populated with indicators that display 306 the location of the subject property and the comparable properties in visually distinguishable fashion on the map image. The number of comparable properties that are shown can be predetermined or may be configurable based upon user preferences. The number of comparable properties that are shown may also update depending upon the level of granularity of the mage image. That is, when the user updates 312 the map image such as by zooming out to encompass a wider geographic area, when the map image updates 314 additional comparable properties may be rendered in addition to those rendered at a more local range.

The user may also prompt a particular comparable property to be highlighted 310, such as by cursor rollover or selection of an entry for the comparable property in a listing. When the application receives 308 an indication that a property has been selected, it is highlighted in the map. Conversely, the user may also select the indicator for a property on the map image, which causes display of the details corresponding to the selected property.

Updating of the map image, highlighting of selected properties, and other review of the property data continues until termination (316) of the current session.

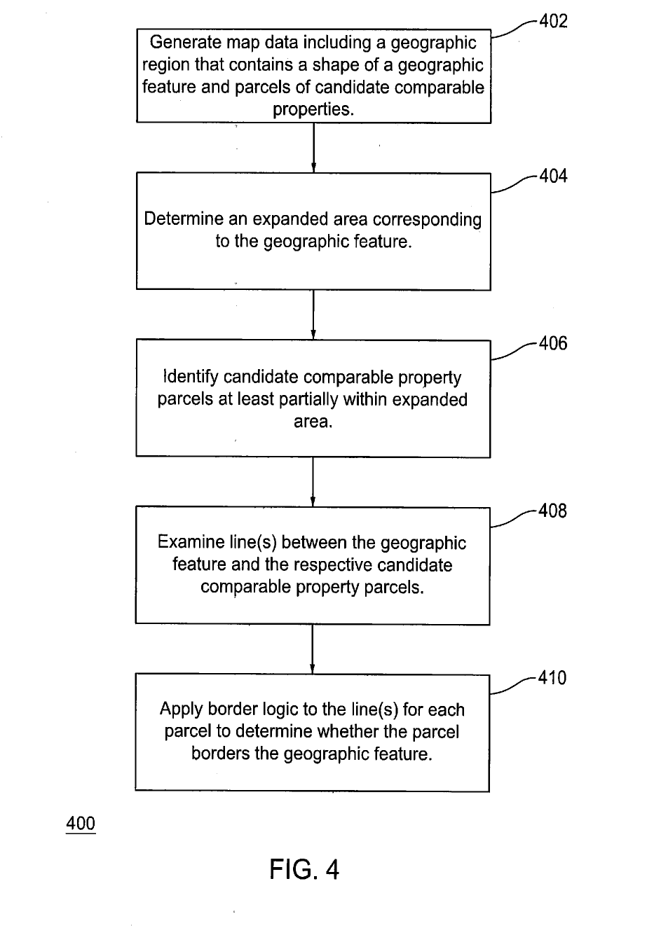

FIG. 4 is a flow diagram illustrating a process 400 for determining proximity to a geographic feature. In this example, the geographic feature may be a body of water, which may be constituted as a shape on a map image and corresponding map data.

Specifically, a given geographic region (MSA, county, zip, Census tract/group, etc.) and a geographic feature of interest are generated 402 as shapes on a map, such as through a GIS as described. Parcel data for candidate comparable properties is also populated on the generated 402 map data.

An initial processing is made to determine the set of candidate comparable properties that will be considered for proximity to the geographic feature of interest. This may be performed by determining 404 an expanded area corresponding to the geographical feature of interest, followed by identification 406 of candidate comparable properties at least partially within the expanded area.

For example, for a given geographic region, the shape of the region (“Shape A”) and the shape of the feature of interest (“Shape B”) are saved. The shape of the region, Shape A, is then expanded outward a given distance. The expanded portion of Shape A forms a new shape (“Shape C”). Where Shape C shares the same space as Shape B is saved as a new shape (“Shape D”), which is the overlap between the expanded parts of the region and the feature's shape. Shape D is then expanded outward onto the original region shape, Shape A, to create Shape E. Parcels of land on Shape A that fall within Shape E are included as candidate comparable property parcels subject to further analysis as to whether they actually border the feature of interest.

Once the candidate comparable property parcels are identified, they are further examined to determine proximity to the geographical feature of interest. In one embodiment, bordering proximity is sought and determined. Bordering proximity means that the parcel is determined to be adjacent to the geographic feature of interest, without intervening property parcels. Bordering proximity may be determined by examining lines extending between one or more locations designated for the candidate comparable property parcel and a location for the geographical feature of interest (408). Then, border logic is applied to the lines corresponding to each candidate comparable property parcel in order to determine whether the parcel borders the geographical feature (410).

Generally, the border logic examines whether there are intervening parcels between the parcel for the candidate comparable property and the geographical feature of interest. Parcels greater than a specified size are excluded from the count of interactions to avoid counting areas which do not represent properties or are in some way part of the feature, such as beaches between properties and bodies of water. Thus, “non-excluded” parcels are deemed property parcels.

For example, lines are directly extended from the centroid of the parcel and the midpoints of all the individual lines which make up the parcel's shape to a location designated for the identified geographic feature. In one example, the closest point of the feature is used as the point of reference for the feature. Alternatives may apply depending upon the type of feature and the decision logic. The number of interactions the line has before interacting with the shape of the geographic feature is tracked.

Various logic may be applied to conclude the bordering condition. For example, if both the line drawn from the centroid and at least one of the lines drawn from the midpoints of the sides of the parcel do not intersect with non-excluded parcels, then the parcel is determined as bordering the geographical feature.

Once all of the candidate comparable properties are examined to determine whether their parcels border the geographical feature, the valuation model may be updated accordingly in order to account for adjustment factors based upon proximity to the geographic feature as described above.

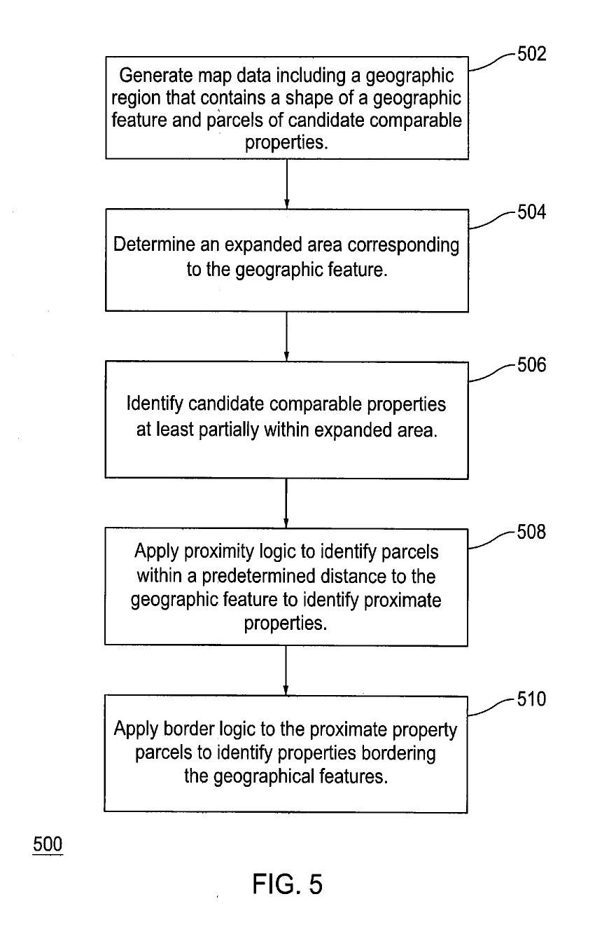

FIG. 5 is a flow diagram illustrating a process 500 for determining proximate property parcels and further distinguishing bordering property parcels. In one embodiment, the explanatory variable used in the regression described above implements a binary determination whether the property borders the geographical feature of interest (that is, “BF” can either be “0” or “1” for the geographical feature in question). Although this aspect is likely more pertinent to the BF variable, the GIS variable may be binary if desired as well. For example, only properties that actually border the ocean are considered to be oceanfront properties. In other embodiments, a first degree of proximity connotes a first value adjustment, and a second degree of proximity connotes a second value adjustment. The second value adjustment has some import, but may differ from the first value adjustment. As an example, oceanfront properties that border the ocean are characterized as a first level, and properties that border the ocean front properties are characterized at a second level. In this sense, the determination may be according to one of three conditions ((1) properties bordering ocean; (2) properties bordering ocean front properties (i.e., next-closest properties to ocean), and (3) no bordering (i.e., houses neither under (1) or (2)). Additionally, alternative embodiments may implement distance based determinations as part of the regression.

The process 500 similarly initiates by determining the set of candidate comparable properties that will be considered for proximity to the geographic feature of interest by generating 502 the relevant map data, determining 504 an expanded area corresponding to the geographical feature of interest and then identifying 506 parcels at least partially within the expanded shape of the area of overlap for further consideration whether they should be considered to have proximity to the geographical feature of interest.

Proximity logic is then applied 508 to determine whether the parcels are sufficiently proximate to the geographic feature of interest. For a border feature (BF) analysis, bordering the feature of interest may be determined. Alternatively, a physical distance between a location designated for the parcel (e.g., centroid) and a location designated for the feature of interest (e.g., closest point on feature perimeter) may be examined to determine whether it is within a threshold distance deemed as providing sufficient proximity. For example, for a beach property, a parcel determined to be within 0.5 miles of the geographic feature of interest (ocean, beach) may be determined as proximate to the geographic feature of interest. In one embodiment, this may be reflected with the GIS explanatory variable. In this fashion, the model accommodates one variable that indicates bordering (BF) and another that indicates distance proximity (GIS), each for a variety of potential geographical features of interest (and sometimes the same one).

Following application of the proximity logic, the set of candidate comparable properties within sufficient proximity may be associated with an adjustment factor for such proximity. However, a subset of the proximate properties may merit a different adjustment, because the subset of the proximate properties borders the geographical feature of interest. Accordingly, border logic is applied 510 in order to determine which of the parcels also borders the feature. The border logic may be as described previously regarding FIG. 4. For the bordering parcels, a different adjustment factor is applied.

It should be understood that an ocean or other body of water is not the only geographic feature of interest. As one alternative, a particular road may be a geographic feature of interest. Properties on one side of the road may merit an adjustment factor that differs from properties on another side of the road. Additionally, the proximity and border logic may involve different adjustments. For example, while proximity to one side of the road may connote a certain adjustment, it may be undesirable to actually border the road (in contrast to the ocean example). Adjustment factors for these and other examples of geographic features may be determined and applied by the valuation model described herein, with adjustments to include additional explanatory variables where appropriate.

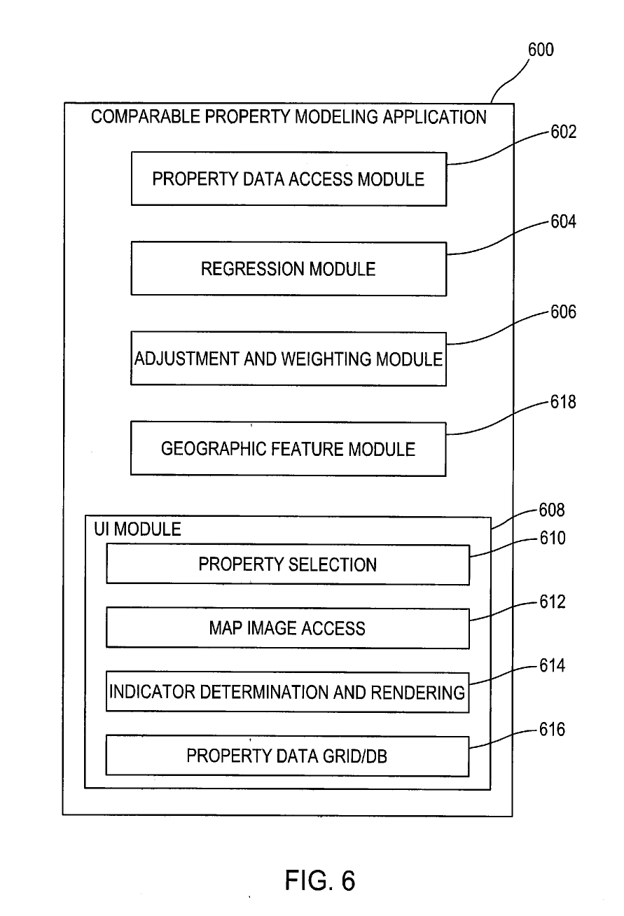

FIG. 6 is a block diagram illustrating an example of a comparable property modeling application 600. The application 600 preferably comprises program code that is stored on a computer readable medium (e.g., compact disk, hard disk, etc.) and that is executable by a processor to perform operations in support of modeling and mapping comparable properties.

According to one aspect, the application includes program code executable to perform operations of accessing property data corresponding to a geographic area, and performing a regression based upon the property data, with the regression modeling the relationship between price and explanatory variables. A subject property and a plurality of comparable properties are identified, followed by determining a set of value adjustments for each of the plurality of comparable properties based upon differences in the explanatory variables between the subject property and each of the plurality of comparable properties. An economic distance between the subject property and each of the comparable properties is determined, with the economic distance constituted as a quantified value determined from the set of value adjustments for each respective comparable property. Once the properties are identified and the adjustments are determined, there is a weighting of the plurality of comparable properties based upon the appropriateness of each of the plurality of comparable properties as comparables for the subject property, the weighting being based upon one or more of the economic distance from the subject property, geographic distance from the subject property, and age of transaction.

The application 600 also includes program code for displaying a map image corresponding to the geographic area, and displaying indicators on the map image indicative of the subject property and at least one of the plurality of comparable properties, as well as ranking the plurality of comparable properties based upon the weighting, and displaying a text listing of the plurality of comparable properties according to the ranking. Finally, the application is configured to receive input indicating selection of comparable properties and to update the map images and indicators as described.

The comparable property modeling application 600 is preferably provided as software, but may alternatively be provided as hardware or firmware, or any combination of software, hardware and/or firmware. The application 600 is configured to provide the comparable property modeling and mapping functionality described herein. Although one modular breakdown of the application 600 is offered, it should be understood that the same functionality may be provided using fewer, greater or differently named modules.

The example of the comparable property modeling application 600 of FIG. 6 includes a property data access module 602, regression module 604, adjustment and weighting module 606, geographic feature module 618, and UI module 608, with the UI module 608 further including a property selection module 610, map image access module 612, indicator determining and rendering module 614 and property data grid/DB module 616.

The property data access module 602 includes program code for carrying access and management of the property data, whether from internal or external resources. The regression module 604 includes program code for carrying out the regression upon the accessed property data, according to the regression algorithm described above, and produces corresponding results such as the determination of regression coefficients and other data at the country (or other) level as appropriate for a subject property. The regression module 604 may implement any conventional code for carrying out the regression given the described explanatory variables and property data.

The adjustment and weighting module 606 is configured to apply the exclusion rules, and to calculate the set of adjustment factors for the individual comparables, the economic distance, and the weighting of the comparables.

The geographic feature module 618 manages the identification of geographic features, processing of rendered shapes for the geographic features, and application of logic and corresponding determinations whether properties are proximate to the geographic features, such as through the functionality described in connection with FIGS. 4-5 above.

The UI module 608 manages the display and receipt of information to provide the described functionality. It includes a property selection module 610, to manage the interfaces and input used to identify one or more subject properties, from which a determination of the corresponding geographic area is determined in support of defining the scope of the regression and other functionality. The map image access module 612 accesses mapping functions and manages the depiction of the map images as well as the indicators of the subject property and the comparable properties. The indicator determination and rendering module 614 is configured to manage which indicators should be indicated on the map image depending upon the current map image, the weighted ranking of the comparables and predetermined settings or user input. The property data grid/DB 616 manages the data set corresponding to a current session, including the subject property and pool of comparable properties. It is configured as a database that allows the property data for the properties to be displayed in a tabular or grid format, with various sorting according to the property characteristics, economic distance, geographic distance, time, etc.

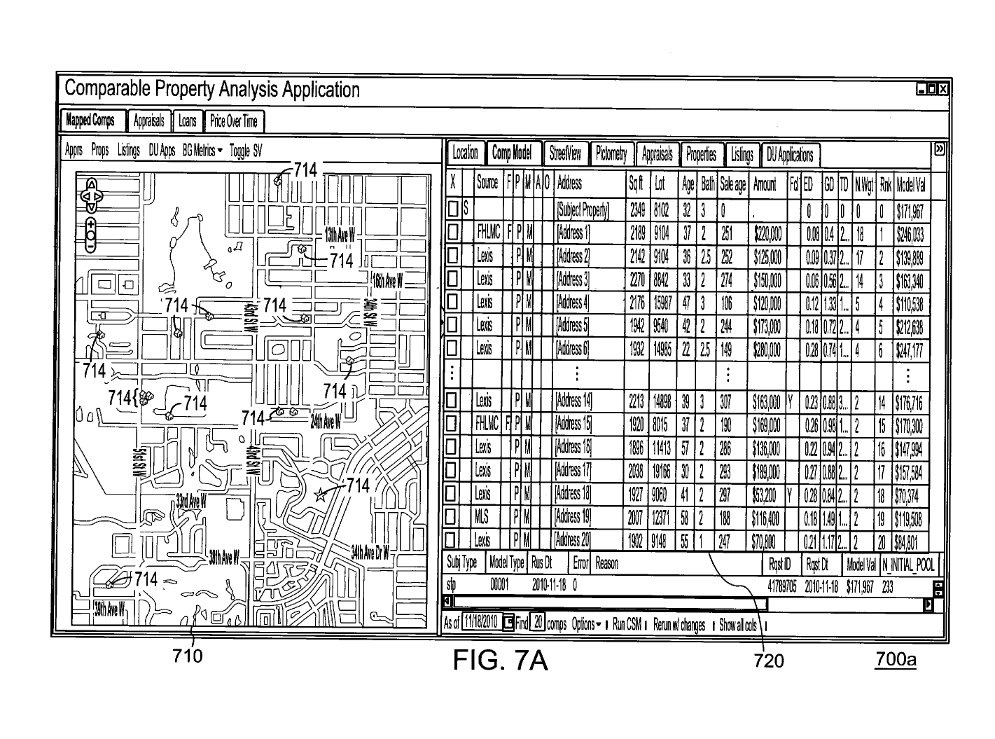

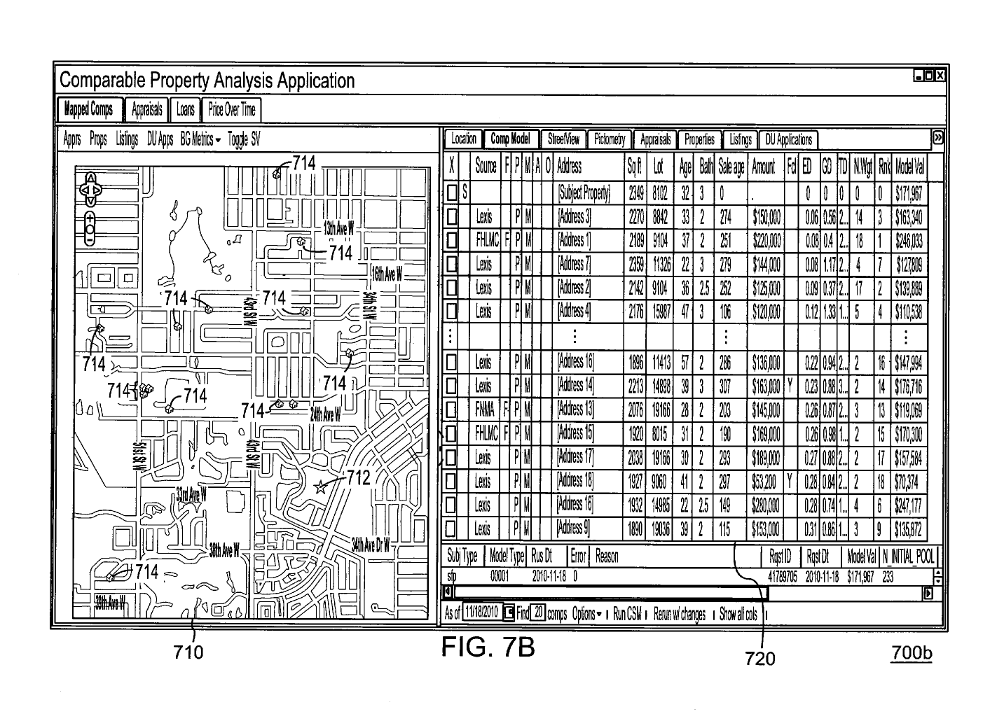

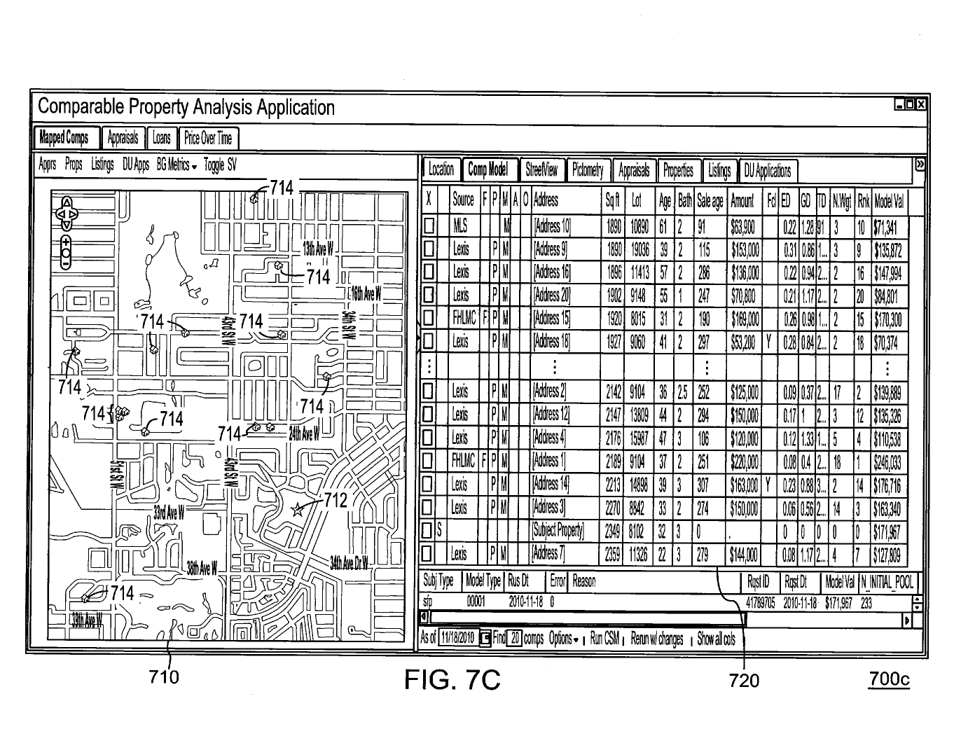

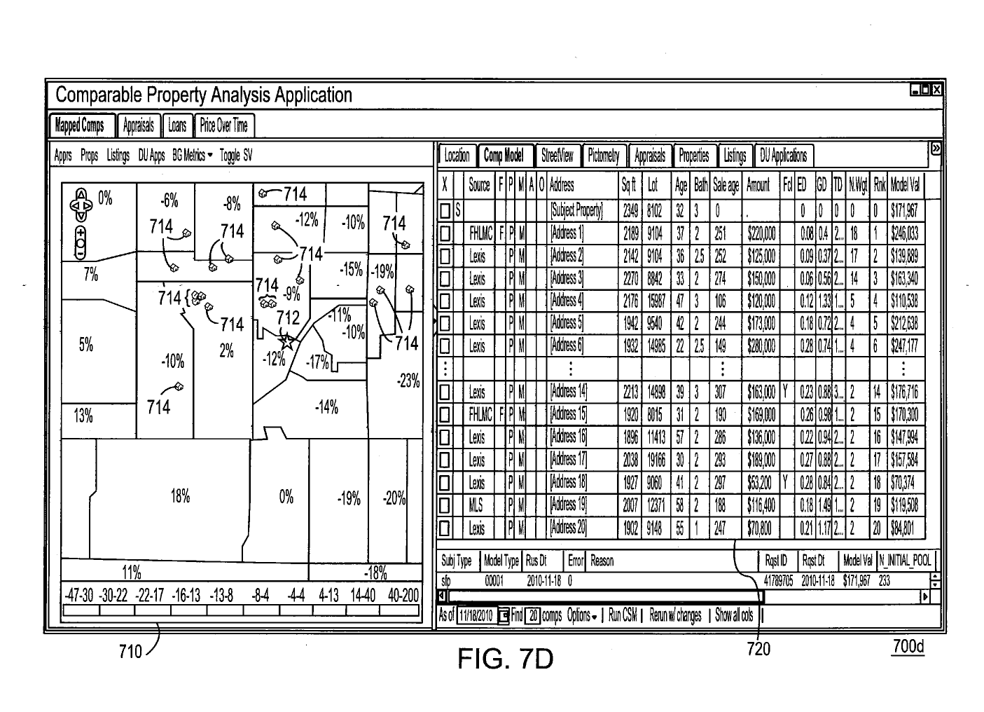

FIGS. 7A-D are display diagrams illustrating examples of map images and corresponding property grid data generated by the comparable property modeling application.

For example, FIG. 7A illustrates an example of a display screen 700a that concurrently displays a map image 710 and a corresponding property data grid 720. This screen may be displayed following selection of a subject property by a user followed by prompting a running of the comparable property model, which identifies the comparable properties, determines adjustment factors, determines economic distance and weights the comparable properties, such as described above.

The map image 710 depicts a region that can be manipulated to show a larger or smaller area, or moved to shift the center of the map image, in convention fashion. This allows the user to review the location of the subject property 712 and corresponding comps 714 at any desired level of granularity. This map image 710 may be separately viewed on a full screen, or may be illustrated alongside the property data grid 720 as shown.

The property grid data 720 contains a listing of details about the subject property and the comparable properties, as well as various information fields. The fields include an identifier field (e.g., “S” indicates the subject property), the source of data for the property (“Source”), the address of the property (“Address”), the square footage (“Sq Ft”), the lot size (“Lot”), the age of the property (“Age”), the number of bathrooms (“Bath”), the age of the prior sale (“Sale Age”), the prior sale amount (“Amount”), the foreclosure status (“FCL”, y/n), border feature status (“BF”, not shown), GIS feature status (“GIS”, not shown), the economic distance (“ED”), geographic distance (“GD”) and time distance (“TD”, e.g., as measured in days) factors as described above, the weight (“N. Wgt”), the ranking by weight (“Rnk”), and the valuation as determined from the comparable sales model (“Model Val”).

The map image 710 allows the user to place a cursor over any of the illustrated properties to prompt highlighting of information for that property and other information. Additionally, the listing of comparables in the property grid data 720 can be updated according to any of the listed columns. For example, the display screen 700b in FIG. 7B illustrates the listing sorted by the economic distance, and the display screen 700c in FIG. 7C illustrates sorting according to the square footage of the properties. The grid data can be variously sorted to allow the user to review how the subject property compares to the listed comparable properties.

According to another aspect, the map image 710 can be divided into regions to help further assess the location of the subject property and corresponding properties. FIG. 7D illustrates the map image 710 updated to indicate several Census Block Group (CBG) regions 716 in the map image 710. The various CBGs 716 are illustrated as separated by dark lines. Additionally, within each CBG 716 the map image is updated to indicate a relative adjustment as compared to a country average for each CBG. This helps the user to further assess how the subject property relates to the comparable properties, with the CBG acting as a proxy for neighborhood.

The user may variously update the map image and manipulate the property data grid in order to review and assess and subject property and the corresponding comparable properties in a fashion that is both flexible and comprehensive.

Thus embodiments of the present invention produce and provide methods and apparatus for modeling and mapping comparable properties. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for estimating property value, the method comprising:
accessing property data corresponding to a geographic area;
identifying a geographic feature within the geographic area;
performing a regression based upon the property data, the regression modeling the relationship between price and explanatory variables, the explanatory variables including a proximity to the geographic feature;
identifying a subject property;
automatically determining a set of value adjustments based upon differences in the explanatory variables between the subject property and each of a plurality of comparable properties, the set of value adjustments including a determination of the proximity to the geographic feature for the subject property and the plurality of comparable properties; and
estimating a value for the subject property based upon the set of value adjustments.

2. The method of claim 1, further comprising:
accessing map data including a shape for the geographic feature and parcels of candidate comparable properties;
determining an expanded area corresponding to the geographic feature; and
determining the proximity to the geographic feature includes determining whether the expanded area overlaps a parcel of a candidate comparable property.

3. The method of claim 2, wherein determining the proximity to the geographic feature further includes examining a line extending between a location designated for the geographic feature and a location designated for the parcel of the candidate comparable property.

4. The method of claim 3, wherein determining the proximity to the geographic feature includes determining a bordering proximity, and wherein determining the bordering proximity includes determining whether an intervening non-excluded parcel is present along the line between the geographic feature and the parcel of the candidate comparable property.

5. The method of claim 4, wherein the line extends between a centroid of the parcel for the candidate comparable property and a midpoint of lines constituting the shape for the geographic feature.

6. The method of claim 2, wherein determining the proximity to the geographic feature further comprises:
examining a centroid line extending between a centroid of the parcel for the candidate comparable property and a location designated for the parcel of the candidate comparable property;
examining a plurality of midpoint lines extending between respective midpoints of lines forming the boundaries of the parcel of the candidate comparable property; and
determining a bordering proximity of the candidate comparable property to the geographic feature where the centroid line and at least one of the plurality of midpoint lines do not include an intervening non-excluded parcel.

7. The method of claim 1, wherein the explanatory variable for the proximity to the geographic feature comprises a categorical determination whether the subject property borders the geographic feature.

8. The method of claim 1, wherein the explanatory variable for the proximity to the geographic feature depends upon the physical distance between the subject property and the geographic feature.

9. A system for estimating property value, the system comprising:
means for accessing property data corresponding to a geographic area;
means for identifying a geographic feature within the geographic area;
means for performing a regression based upon the property data, the regression modeling the relationship between price and explanatory variables, the explanatory variables including a proximity to the geographic feature;
means for identifying a subject property;
means for automatically determining a set of value adjustments based upon differences in the explanatory variables between the subject property and each of a plurality of comparable properties, the set of value adjustments including a determination of the proximity to the geographic feature for the subject property and the plurality of comparable properties; and
means for estimating a value for the subject property based upon the set of value adjustments.

10. The system of claim 9, further comprising:
means for accessing map data including a shape for the geographic feature and parcels of candidate comparable properties;
means for determining an expanded area corresponding to the geographic feature; and
means for determining the proximity to the geographic feature includes determining whether the expanded area overlaps a parcel of a candidate comparable property.

11. The system of claim 10, wherein determining the proximity to the geographic feature further includes examining a line extending between a location designated for the geographic feature and a location designated for the parcel of the candidate comparable property.

12. The system of claim 9, wherein the explanatory variable for the proximity to the geographic feature comprises a categorical determination whether the subject property borders the geographic feature.

13. A computer program product for estimating property value, comprising a non-transitory computer readable medium having program code stored thereon, the program code being executable to perform operations comprising:
accessing property data corresponding to a geographic area;
identifying a geographic feature within the geographic area;
performing a regression based upon the property data, the regression modeling the relationship between price and explanatory variables, the explanatory variables including a proximity to the geographic feature;
identifying a subject property;
automatically determining a set of value adjustments based upon differences in the explanatory variables between the subject property and each of a plurality of comparable properties, the set of value adjustments including a determination of the proximity to the geographic feature for the subject property and the plurality of comparable properties; and
estimating a value for the subject property based upon the set of value adjustments.

14. The computer program product of claim 13, wherein the operations further comprise:
accessing map data including a shape for the geographic feature and parcels of candidate comparable properties;
determining an expanded area corresponding to the geographic feature; and
determining the proximity to the geographic feature includes determining whether the expanded area overlaps a parcel of a candidate comparable property.

15. The computer program product of claim 14, wherein determining the proximity to the geographic feature further includes examining a line extending between a location designated for the geographic feature and a location designated for the parcel of the candidate comparable property.

16. The computer program product of claim 15, wherein determining the proximity to the geographic feature includes determining a bordering proximity, and wherein determining the bordering proximity includes determining whether an intervening non-excluded parcel is present along the line between the geographic feature and the parcel of the candidate comparable property.

17. The computer program product of claim 16, wherein the line extends between a centroid of the parcel for the candidate comparable property and a midpoint of lines constituting the shape for the geographic feature.

18. The computer program product of claim 14, wherein determining the proximity to the geographic feature further comprises:
examining a centroid line extending between a centroid of the parcel for the candidate comparable property and a location designated for the parcel of the candidate comparable property;
examining a plurality of midpoint lines extending between respective midpoints of lines forming the boundaries of the parcel of the candidate comparable property; and
determining a bordering proximity of the candidate comparable property to the geographic feature where the centroid line and at least one of the plurality of midpoint lines do not include an intervening non-excluded parcel.

19. The computer program product of claim 13, wherein the explanatory variable for the proximity to the geographic feature comprises a categorical determination whether the subject property borders the geographic feature.

20. The computer program product of claim 13, wherein the explanatory variable for the proximity to the geographic feature depends upon the physical distance between the subject property and the geographic feature.
